(19) United States
(12) Patent Application Publication
(10) Pub. No.: US 2021/0110325 A1
(43) Pub. Date: Apr. 15, 2021

(54) ON-DEMAND DYNAMIC PROVISIONING OF PARKING SPACES

(71) Applicant: Drivewey Technologies Inc., Spring Valley, CA (US)

(72) Inventors: Matthew Delbruegge, Spring Valley, CA (US); Robert Wright, Virginia Beach, VA (US)

(21) Appl. No.: 16/893,435

(22) Filed: Jun. 5, 2020

Related U.S. Application Data
(60) Provisional application No. 62/856,754, filed on Jun. 4, 2019.

(51) Int. Cl. G06Q 10/06; G06Q 10/10; G06Q 10/02; G06Q 30/00; G06F 16/9537; G06F 16/9538; G06F 16/9535; H04L 29/08; G06F 3/0482; G06F 3/0484

(52) U.S. Cl. CPC G06Q 10/06315; G06Q 10/10; G06Q 10/02; G06Q 30/0185; G06F 16/9537; G06Q 2240/00; G06F 16/9535; H04L 67/306; G06F 3/0482; G06F 3/04847; G06F 16/9538

(57) ABSTRACT

Dynamic provisioning of parking spaces on-demand can include receiving search requests from first user devices, searching a register based on user types and locations associated with the search requests, and causing search results to be displayed on graphical user interfaces (“GUI”) of the first user devices. Linked user options can be determined with a server based on space assets selected from the search results, user registration profiles, or the search requests. Correspondence can be sent between the first user devices and second user devices associated with users that are linked to users of the first user devices or control access to selected space assets Linked user options can be displayed on GUIs of first and second user devices based on the correspondence and space assets selected Space assets can be provisioned by the server based on provisioning agreements facilitated through the first and second user devices.

### BACKGROUND

Today, there is a decreasing supply of public on-street parking spaces for drivers. On-demand system using portable computing device to parking and pay for vehicle parking does not exist in today's vehicle parking economy. This often results in limited options for driver in the forms of limited public parking on the street, decreased supply of street meters PLUS (limit drivers to 2 hrs only). In short, public parking model lacks 21st century technology SUMMARY

Examples described herein include systems and methods for dynamically provisioning of parking spaces on-demand. In one example the method can include receiving, with a server, a search request from a first user device associated with a first user. In another example a register can be searched based on a user type and a location associated with the search request, and the search results can be displayed on a first graphical user interface (“GUI”) for the first user device. In another example the server can determine linked user options based on a space asset selected from the search results and one of the search request and a user registration profile. In addition, the server can send correspondence between the first user device and a second user device regarding the first space asset, the second user device being associated with a second user that is one of linked to the first user and controls access to the space asset. Further, a portion of the linked user options can be displayed on at least one of the first GUI and a second GUI of the second user device based on the correspondence and the first space asset. In another example, the server can provision the first space asset based on a first space provisioning agreement involving the first user and the second user, the provisioning including transmitting a first agreement confirmation to the first user device and the second user device.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for dynamically provisioning different types of parking spaces on-demand.

FIG. 2 illustrates a flowchart for an exemplary method for registering users including operators, hosts, and partners with a computer-implemented parking space provisioning system.

FIG. 3 illustrates a sequence diagram of an example method for provisioning space assets associated with operators and hosts including parking spaces.

FIG. 4 illustrates a sequence diagram of an example method for provisioning space assets to linked users and monitoring utilizations of provisioned parking spaces.

FIG. 5 is an illustration of exemplary system components for dynamically provisioning parking spaces on-demand.

FIGS. 6 and 7 each illustrate a respective example graphical user interface (“GUI”) of a user device being operated to perform various methods described herein associated with an operator service.

FIG. 8 illustrates an example GUI of a user device being operated to enable coordination between linked users.

FIGS. 9 and 10 each illustrate a respective example GUI of a user device being operated to perform various methods described herein associated with a host service.

FIG. 11 illustrates an example GUI of a user device being operated to review an inventory of parking spaces.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

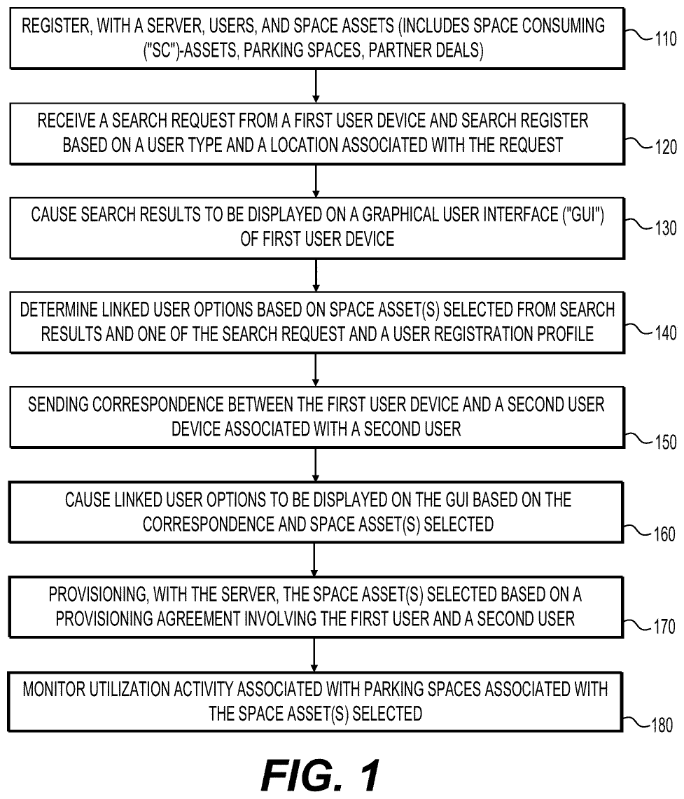

FIG. 1 is a flowchart of an example method for dynamically provisioning different types of parking spaces on-demand. At stage 110, a system according to the present disclosure operates one or more servers to register users and space assets. As defined herein, users can include operators, hosts, and partners.

An operator includes an individual or an entity (public or private) that includes one or individuals that own and/or operate a space consuming asset (“sc-asset”). An sc-asset can include a vehicle of any type, such as an automobile, a boat or other sea-going vessel such as a jet ski, an airplane, a motor cycle, an self-moving trailer, a trailer that is towed, or any other type of vehicle that is operated to transport people or goods and must be parked in a space large enough to accommodate that vehicle in such a way as to no obstruct a path used to reach a location of the space.

A host can include an individual or an entity (public or private) that includes one or more individuals that own or otherwise control access to a parking space. A parking space can include a space in a driveway or a garage at a residential address, a boat slip at a marina, a slot in a bike rack, a space in an airplane hanger, parking spaces in a multi-level garage, or any other space or group of spaces that can accommodate a vehicle as defined herein.

A partner can include any type of public or private individual or entity that includes one or more individuals that can enter into agreements with hosts to offer deals or promote products, events, food, services, or other types of items or permissions that can be the subject of a deal, a discount, or some type of add-on.

In one example, any of an operator, a host, or a partner can also be a user of another user type. More specifically, an operator can also be a host, or a partner, or a host and partner and vice versa.

In stage 110, the server can register users and space assets requesting, receiving, organizing, and storing specific information based on a type of user or space asset. The specific information can be stored by the server in register database hosted on the server or maintained through a cloud service. In one example, the server includes one or more servers, each including one or more processors, a memory storage, and a non-transitory computer-readable medium containing instructions that are executed by the processors. In another example, the server may be a cloud server that implements software to monitor and manage data, software components, and hardware components associated or otherwise in communication with the server. Further, server can direct the functionality of applications, such as a parking space provisioning application, installed on other computing devices.

The specific information about users and space assets can be provided to the server through user devices associated with the users. In one example, a user device includes a computing device, such as a phone, a tablet, a laptop, desktop computer, in-dash unit (in an automobile), on-board computing unit (for a boat); or other device including a processor, a memory storage, and a non-transitory computer-readable medium containing instructions that are executed by the processor. The user devices may transmit the specific information over a network such as the internet or a cellular network, or in wireless (e.g., Bluetooth, near-field communication, peer-to-peer, or the like) or wired fashion using one or more components

In stage 120, a search request for space assets can be received from a user device. The search request can be submitted through an operator-, a host-, or partner-service that is part of a space asset provisioning application installed on or otherwise accessible by the first user device and configured to operate or instruct an operating system to operate a GUI of the first user device. In one example, the search request can be for any type of space asset and one or more criteria for the search can be specified through the operator-, host-, or partner-service operating on the first user device.

In one example, a user can specify a type of parking space such as a boat slip, a car parking space, other type of parking space as described above. In another example, a search request can further specify a sub-type of a particular type of parking space being searched for. For example, for an automobile parking space, a user can request street, residential, or commercial lot parking spaces. Duration, scheduled time needed, number of adjacent parking spaces, rate, type of rate (e.g., hourly, by the minute, daily), can also be specified as a search criteria corresponding to data fields populated in a register database for space assets that have been registered. Other search criteria can include size of a vehicle or parking space to search for or based on, a location, points of interest within a specified proximity to parking spaces.

The server, in stage 120, can execute a search based on a user type of a user submitting the request, and a location specified in the request or associated with the user. More specifically, the system with implements the server conducting the search of the register database can limit types of space assets that will appear in a set of search results to only those: parking spaces that can accommodate the sc-assets of a user submitting the search; operators that have sc-assets that can be accommodates by a parking spaces controlled by a host that a partner submitting the search is partnered with; operators that are also partners; or partners that offer deals exclusively to other registered users.

At stage 130, the server can cause an operator, host, or partner service on a first user device associated with the search request to operate a GUI to display the search results.

In stage 140, the system can determine linked user options based on space assets selected from the search results and at least one of the criteria specified the original search request and a registration profile of a user. In one example, the search request could include a search for multiple space assets, such as adjacent or closely grouped parking spaces for an operator and other operators linked to that operator. In another example, operators can be linked for example, through direct communications (e.g., invitations, friend requests) through a social network implemented by the system. In another example, the registration profile can be associated with an operator, host, or partner that submitted the search request. In one example, the registration profile for the operator can specify other operators that operator wants to, or already is, linked to.

In yet another example, users of different user types can be linked as result of arrangements made between these users, for example between partners and hosts. Thus, a partner deal, such a discount on merchandise, may be offered from a particular partner who sells that merchandise, to all operators that are provisioned parking spaces for a host that has established a business relationship with that particular partner. Thus, the host and particular partner would be identified by the system as linked users, and the partner deal may be displayed every time one of the host's parking spaces is displayed or otherwise included search results.

At stage 150, the server for the system can send correspondence between user devices, including at least one user device that is associated with a user that controls access to the space assets included in the search results. In one example, an operator wishing to have a parking space or deal provisioned to them, can communicate through a messaging service. The messaging service can be part of, or otherwise supported by, versions of the space asset provisioning application installed on the user devices involved. The messaging service can be utilized by an operator or host to communicate with a host or a partner that controls access to a particular space asset that the operator or host is interested in utilizing.

In one example, the search results can indicate availability of the space assets real-time so that the space asset, such a parking space, can be utilized by an operator, for example an operator, on-demand. Thus, an operator going to an event, or a destination for a first time, or a destination like a beach or a city where parking is sparse, can know at any instant, where available spaces are. In particular, that operator can know where available parking spaces are in relation to the destination they are traveling to.

In another example, the system can implement a reservation system that allows operators to have parking spaces provisioned to them at a time in the future. This might be especially useful for events, like sporting events or fireworks shows near a body of water, where parking lots and marinas tend to fill up all once.

At stage 160, the server can cause a portion of the linked options determined in stage 140 to be displayed on a GUI of at least one of the first and second user devices involved in the correspondence in stage 150. In one example, first and second users associated with the first and second user devices can be linked users, and the correspondence can include the first user using the first user device to send or share space assets from the search results to or with the second user device for the second user to be made aware of. In another, example, the first and second users can both be hosts. A first host using the first user device to find additional capacity because his lot or marina is full, and a second host associated with the second user device being an individual or entity that first host has used in the past for overflow purposes.

Correspondence in stage 150 can come in the form of attempts to coordinate group parking among linked users, pricing arrangements, scheduling stipulations, and other aspects of a potential transaction involving the first and second users and the space assets they use (e.g., drive) or control access to.

In stage 170, the system can provision a space asset selected from the search results based on a provisioning agreement involving the first user and a second user. In one example, terms of the provisioning agreement can include a schedule time that the first user will be able to utilized the selected space asset. In another example, the first and second users can be linked users and that the provisioning agreement can specify a number of parking spaces included with the selected space asset. Other terms of the provisioning agreement can include rate type and rate for utilizing the selected space assets, recurring use terms, size of sc-assets permitted in parking spaces associated with the selected space assets, partner deals included with the selected space assets, as well as check-in and check-out policies. In one example, a parking space that is associated with the selected space asset may only be checked-into and checked-out of once. Other agreements may allow multiple check-ins.

In stage 180, the system can monitor utilization activity associated with parking spaces associated with the selected space assets. In one example, monitoring can include issuing notifications to the first user device informing of check-in and check-out times, and requesting check-in and check-out status. In another example, a host that controls access to the selected space asset can view a real-time video of the space asset as it being utilized. In yet another example, a motion sensor that is in communication with a network transmit detection signals to the server which can send notifications to the first and second user devices of an operator and a host, respectively, that are involved in the provisioning agreement. In still another example, the selected space can include multiple parking spaces to be utilized by users linked to the first user. The monitoring in stage 180 can include issuing notifications to the first user and linked users when the first user or other linked users check-in or check-out of their respective parking spaces.

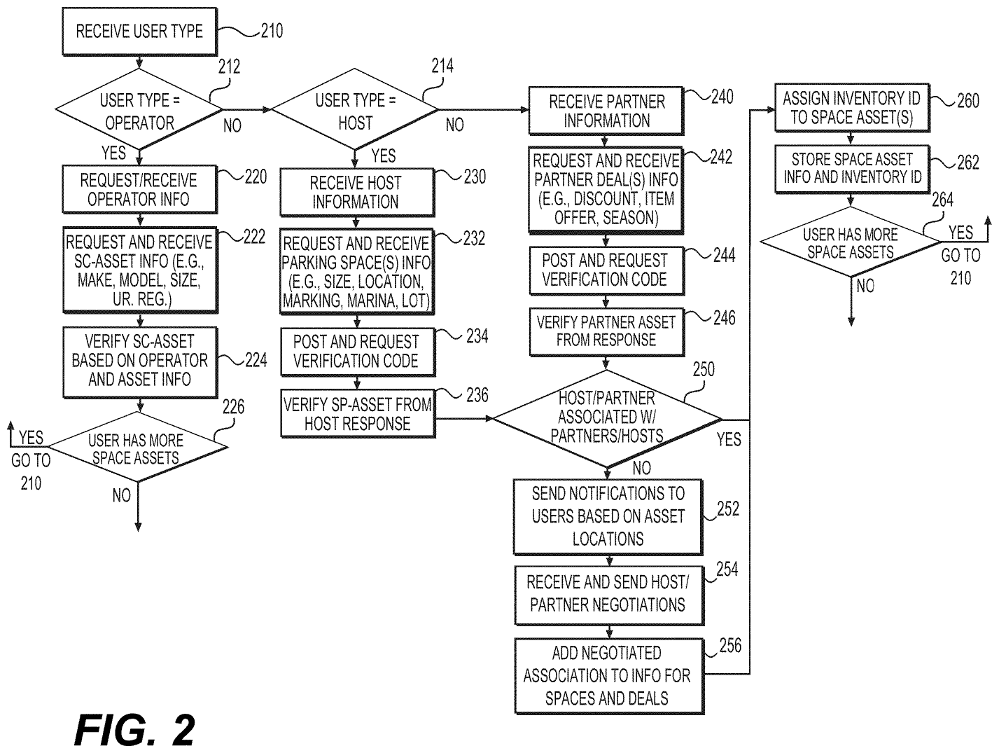

FIG. 2 illustrates a flowchart for an exemplary method for registering users including operators, hosts, and partners with a computer-implemented parking space provisioning system.

In stage 210, a system according to the present disclosure utilize a server can receive an indication of a user type. The indication can be submitted from an application manager of a parking space provisioning application installed on a user device configured to communicate with the server. In one example, a user type can be that of an operator, a host, or a partner as defined herein.

At stage 212, the system can determine the user type indicated is that of an operator and requests and receives information regarding the operator in stage 220. Operator information can include basic identifying information (e.g., name, date of birth, address) as well a license information (e.g., boating license number, vehicle license number, licensing state, social security number). In addition, information requested in stage 220 can include payment information, and permission to store and use that payment information on a recurring basis.

In stage 222, the system, through the server, can request and receive specific information regarding an sc-asset the user has indicated they want to register. Information regarding the sc-asset can include: automobile or boat license number; make, model, year; size; color; registration; insurance carrier; insurance policy number; number of wheels or engines; and any other identifying or descriptive information.

At stage 224, the system can access electronic records systems state, local, or other regulatory agencies to verify the information provided in stages 220 and 222. In another example, the system can perform and authentication process that includes transmitting a verification code to a user device using one mode of communication (e.g., cellular service), and request the code be provides through another mode of communication (e.g., internet, Bluetooth) with the same or a different computing device. In one example, the user device could be installed in the sc-asset and the authentication process could require a verification code sent to the user device be entered on another user device, such as a phone.

In stage 226, the server can issue a request to a user that entered a user type in stage 210 whether the user wishes to register additional sc-assets. In the event the user has another sc-asset or is also a host and/or a partner with a parking space and/or a partner deal the user desires to register, the user may indicate, through a user device that they have more space assets to registers. Otherwise, the system can end a registration process.

Stage 212 can also include the system determining the user type indicated in stage 210 is not an operator user type, and at stage 214, the system can determine that the user type is a host user type.

In stage 230, the system can request and receive host information. This can include a name, address, state of incorporation, business license number, date of formation, point of contact information, and other identifying information. In the case of a host that is an individual with a parking space that is adjacent, in front of, or part of a residence, information requested can include similar information requested of an operator in stage 220.

At stage 232, the system, through the server, can request and receive information regarding the parking spaces that the host controls access to or utilization of. In one example, this information can include: lot or marina address or coordinates; number of spaces or slips; periods for utilization by operators; size; distinct markings; type of lot (e.g., RV, trailer, farmer's market location, dirt); and type of parking space (e.g., residential driveway or garage, vendor spot, street parking, restricted, handicap).

In stage 234, the system can implement an authentication process similar to the verification code processes described with respect to stage 224. More specifically, the system can issue and post a verification code through a mode that the host indicated in stage 230 the host has access to. Then, at stage 236, the host can submit, through a user device in communication with the server of the system, the verification code received.

Turning back to stage 214, depending on the user type indicated in stage 210, the system can determine the user is a partner. As result of this determination, the system can request and receive partner information in stated 240. The information request in this stage can be the same types of information requested of operators and/or hosts in stages 220 and/or 230 respectively.

In stage 242, the system can request and receive, through a user device being used by the partner, information on the space assets—partner deal—the partner may be offering. This information can include: an amount of a discount if parking space is provisioned from a certain host; use of shower stalls near a beach access; a loyalty program in which a certain number of transactions with at a business of the partner entitles another user to a credit with a particular host; status upgrades that entitle users various perks; and other types of deal similar to those already mentioned.

Upon receiving the partner deal information in stage 242, stages 244 and 246 are executed by the system and can include an authentication procedure similar to the one described for stages 234 and 236.

Upon verification at stage 236 or 246, the system can review information in the register database and determine whether a host from stage 236 or a partner of stage 246, is associated with other hosts and partners. In the event that no associations are found, the system can execute stage 252 in which notifications are issued to users based on asset locations. More specifically, notifications may be issued to users associated with locations or space assets located near the host or partner of stage 250, or near space assets associated with the host are partner.

The notifications may include the host or partner information, and information about their space assets. At the same, notifications may be issued to the host or partner including the same type of information for these other users and their space assets.

In stage 254, the host or partner can communicate using the parking space provisioning application on their user devices with the other users identified and/or notified in stage 252. The parties can set up host/partner agreements that may involve offering goods or services, discounts, credits, cross-promotional activity obligations, and other arrangements. At stage 256, any agreements resulting from the negotiations in stage 254 can be added to a profile for the register database, for each of the spaces assets involved in that agreement.

At stage 260, the space assets identified and described in stages 232, 242, and 256 are assigned inventory IDs. In stage 262, the information gathered or specified through negotiations, and assigned in stages 232, 242, 256, and 260 may be stored in the register database in stage 262.

At stage 264, similar to stage 226, the system can request, through a user device, an indication from the host or partner of stage 203 of stage 240 as to whether they have additional space assets to register. In the event the user has another parking space or partner deal or is also an operator, host, and/or a partner with other space assets the user desires to register, the user may indicate, through as user device that they have more space assets to registers. Otherwise, the system can end a registration process.

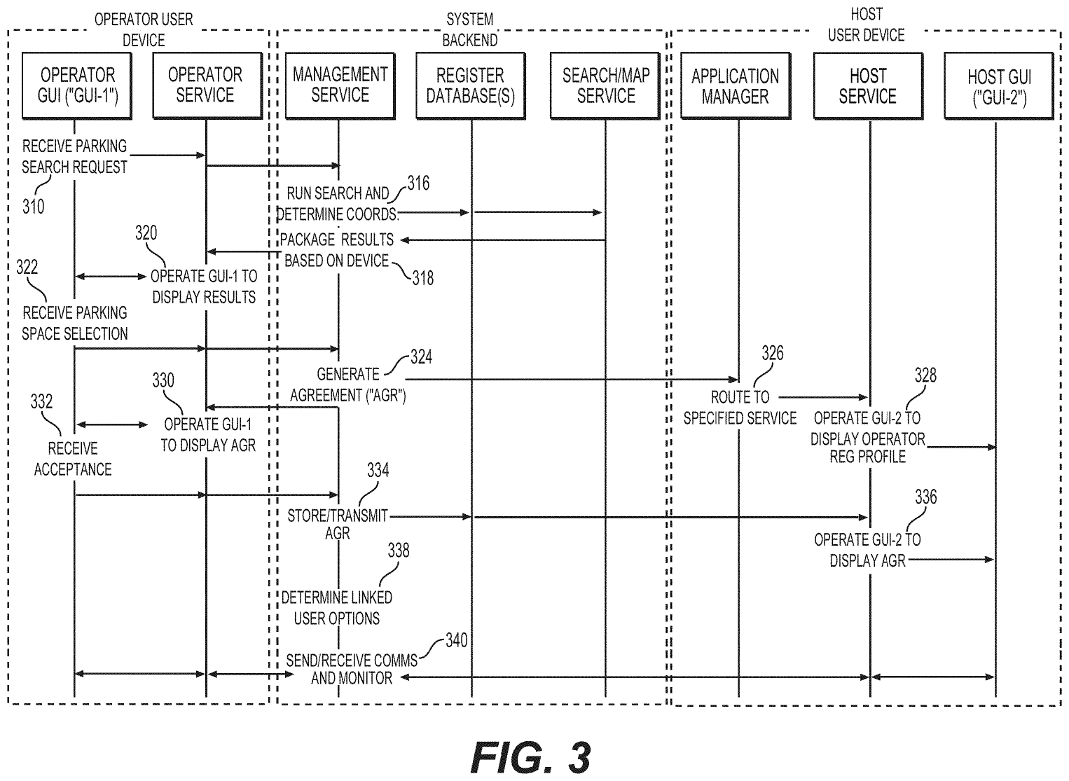

FIG. 3 illustrates a sequence diagram of an example method for provisioning space assets associated with operators and hosts including parking spaces. At stage 310, an operator service can receive a search request entered through a GUI on the operator's user device (“GUI-1”). The search request can be for a parking space that is needed immediately (on-demand). The operator service can forward the search request to a management service implemented by a server of a system backend. The management service may include an application or other software installed on the server that can monitor and manage data, software components, and hardware components associated with the server. Further, the management service can monitor and control functionality and other applications and services on or accessible by the server.

At stage 316, the management service then searches a register database and obtains map coordinates for space assets identified from he register database. In stage 318, the management service packages the search results based on a type of user device that sent the search request. In example, the search results can be transmitted in a format that is compatible the user device which may include a phone, a tablet, a laptop, an in-dash, or on-board unit. In another example, the search results may have to be formatted according to a particular operating system that is run on the user device.

In stage 320, the operator service, having received the search results, operates GUI-1 to display the results. Accordingly, in stage 322 selection of space assets displayed on the GUI-1 can be received and forwarded to the management service by the operator service.

At stage 324, the management service can generate a provisioning agreement for the selected space assets, which it forwards to the operator service and an application manager.

The application manager can be part a parking space provisioning application installed on a second user device of a host that controls access to or otherwise utilization of the selected space assets.

In one example, the application manager may be installed with versions of the provisioning application specifically configured for users that have multiple user types. For example, a host who is associated with the host user device of FIG. 3, may also be an operator and or a partner. The application manager may be included within the provisioning application in order to route communications and information to a correct of one an operator service, a partner service, and the host service with are part of a version of the provisioning application installed on the host device.

Accordingly, as a result of receiving the provisioning agreement from the management service in stage 324, for a space asset controlled by the host of the host operator device, the application manager routes the agreement to the host service in stage 326, which operates a GUI of the operator user device (“GUI-2”) in stage 328 to display a registration Profile of the operator in the GUI-2. In one example, the host may review the registration profile and choose not to offer the space asset to the operator. In particular the registration profile may include ratings of the operator from other users that have entered into provisioning agreements with the operator. These ratings may indicate how (good or bad, reliable or unreliable, pays promptly or not timely) others view the operator as a customer or individual or entity to do business with.

As the host is reviewing the registration profile, the operator service operates the GUI-1 to display the agreement. This can include displaying select option for accepting or declining the agreement. In one example, the provisioning agreement displayed can specify price or rate for a parking space, and amount of time the operator can utilize the parking space, and consequences for overextending the time specified, and a request for payment (e.g., credit card information).

In stage 332, the GUI-1 can receive an indication of acceptance which be forwarded by the operator service to the management service. In stage 334, the management service can store the agreement in the register database as part of the profiles of the operator, space asset, and the host, and forward the same to the host service. In turn, the host service and operate the GUI-2 to display the agreement in stage 336.

In stage 338, the management service can determine linked user options for both the operator and the host. This can include reviewing the registration profiles of the operator, the host, and the selected space asset and: recognizing patterns of behavior with other or common users; identifying other linked users that often enter into provisioning agreements at time proximate to when the operator or host enter into the agreements; partner deals each of the operator and the host have taken advantage of or that have involved the selected space asset; specifics (common provisions) of provisioning agreements entered into by the operator and the host; and other aspects of the profiles that can be tracked or analyzed.

In stage 340, the management service can send and receive communications between the operator, the host, and linked users associated with the operator, host, and or selected space asset. In addition, the management service can monitor utilization of the space asset as previously described herein.

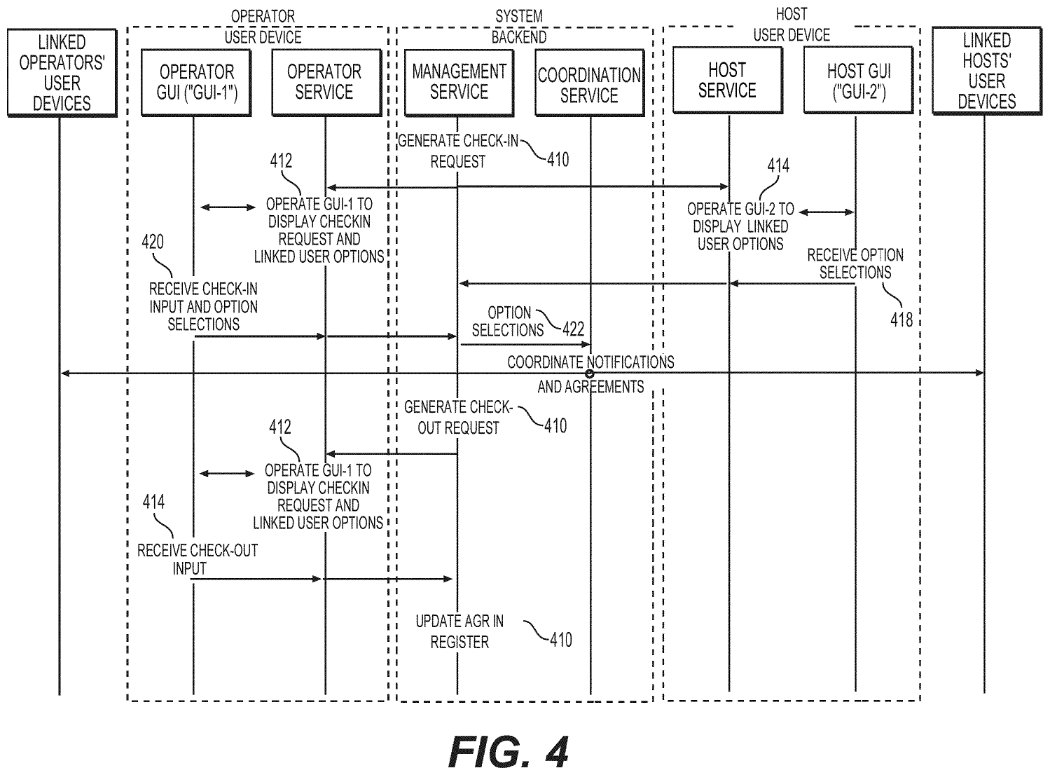

FIG. 4 illustrates a sequence diagram of an example method for provisioning space assets to linked users and monitoring utilizations of provisioned parking spaces.

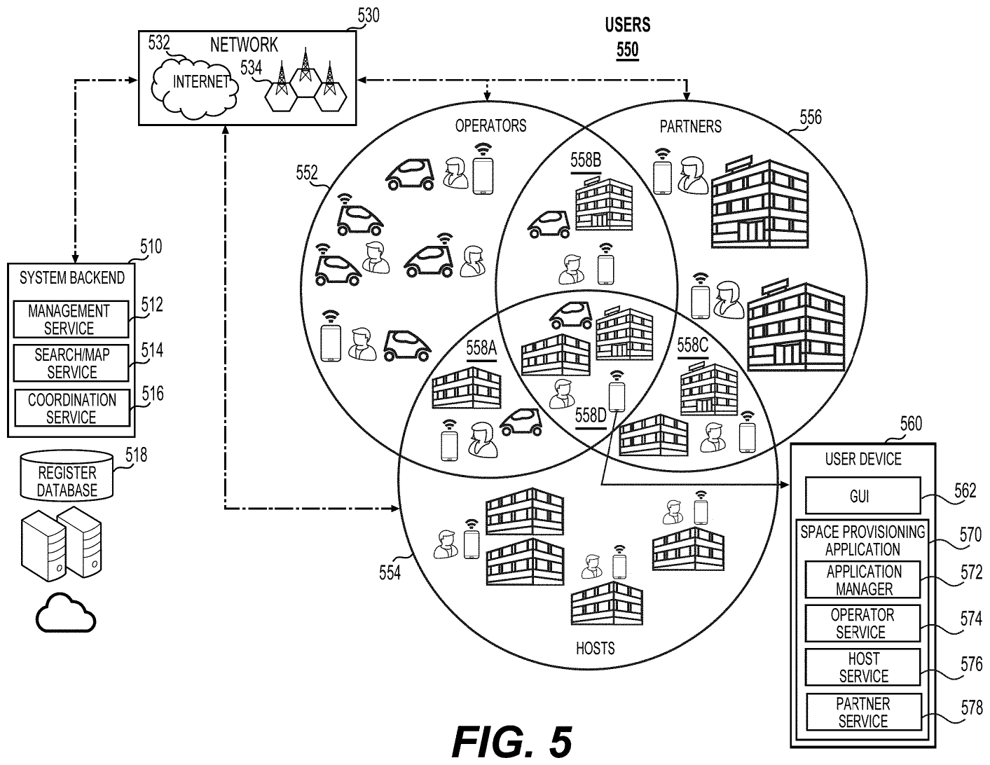

FIG. 5 is an illustration of exemplary system components for dynamically provisioning parking spaces on-demand.

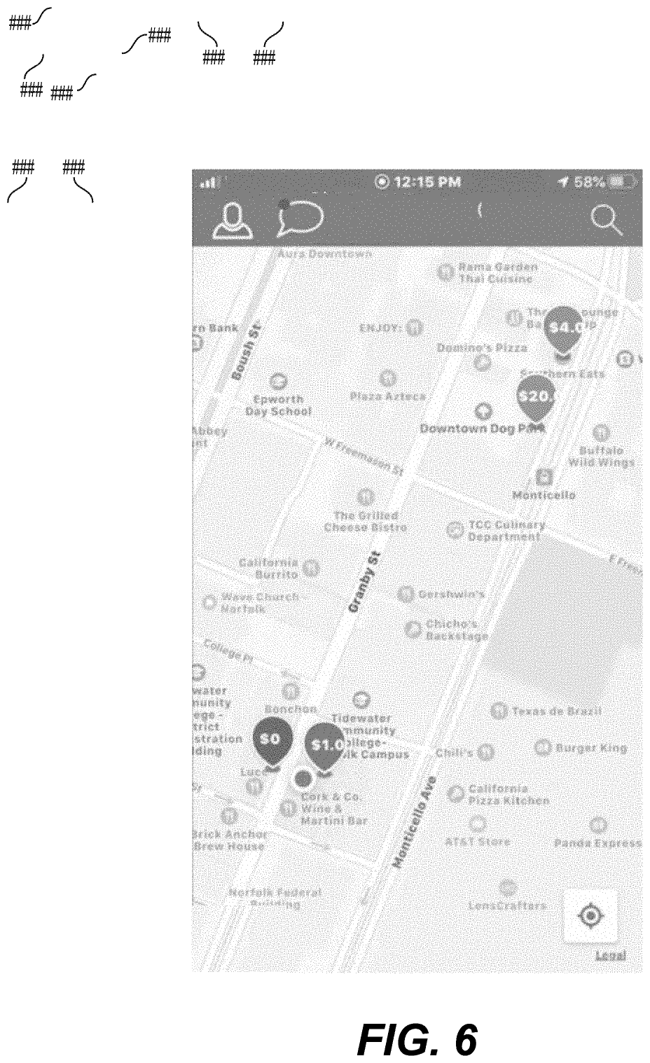

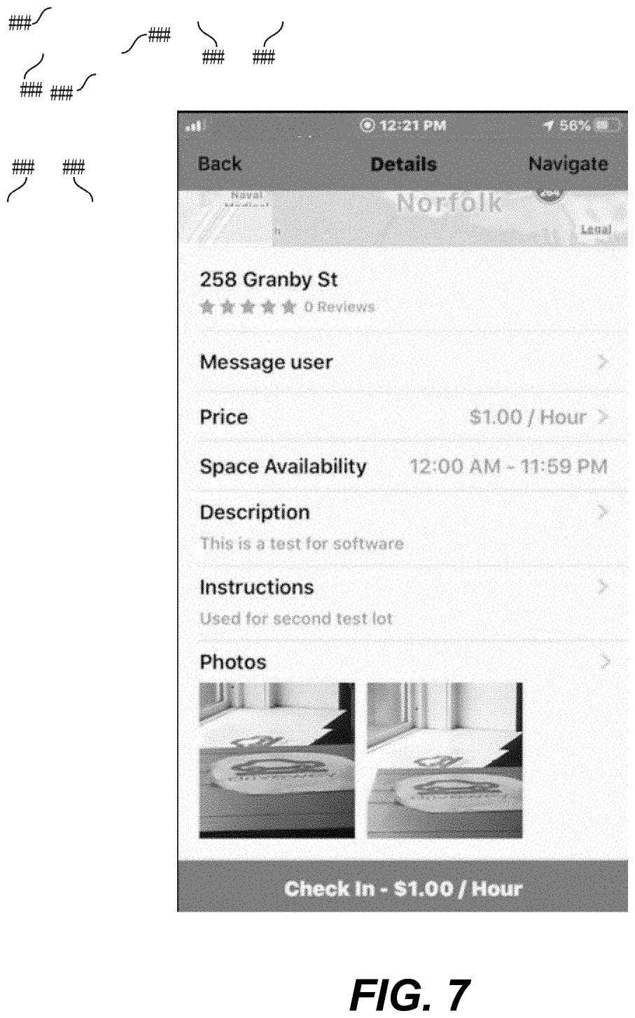

FIGS. 6 and 7 each illustrate a respective example graphical user interface (“GUI”) of a user device being operated to perform various methods described herein associated with an operator service.

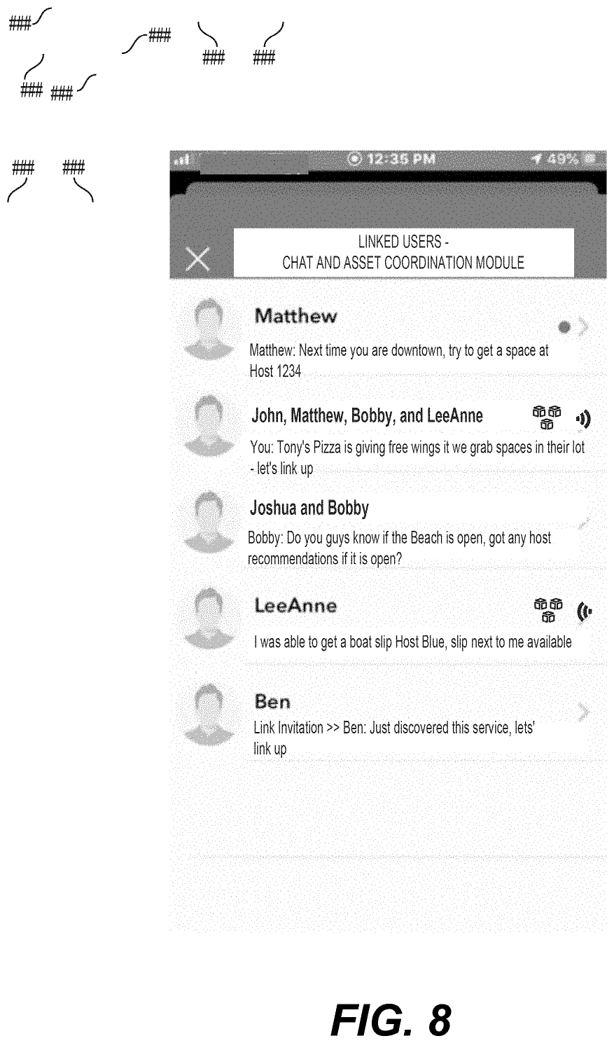

FIG. 8 illustrates an example GUI of a user device being operated to enable coordination between linked users.

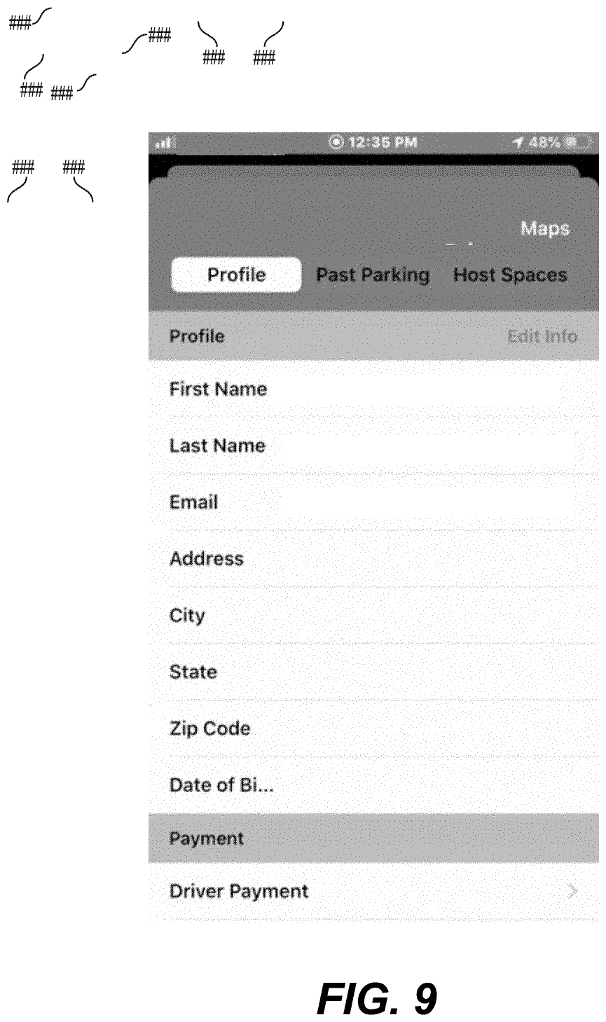

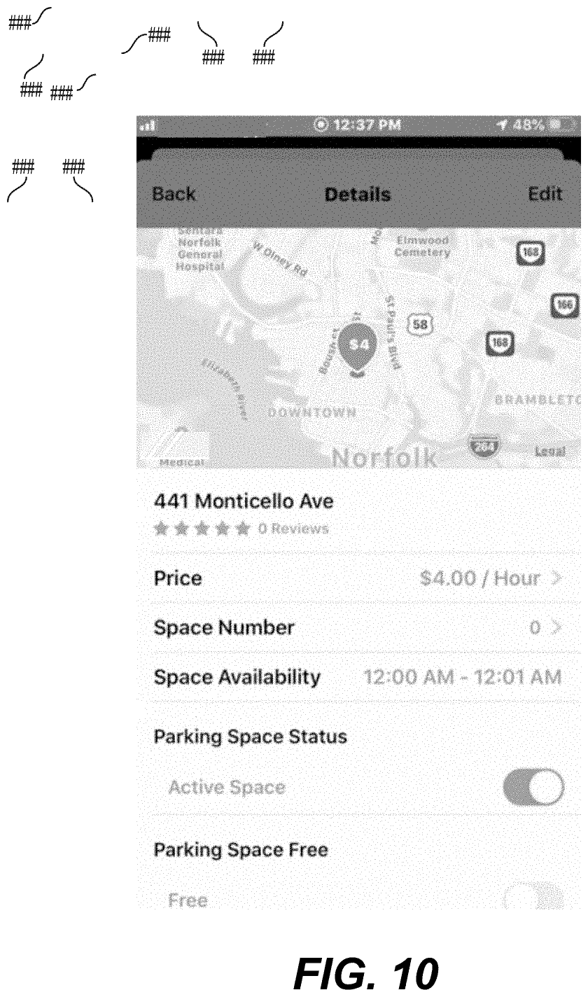

FIGS. 9 and 10 each illustrate a respective example GUI of a user device being operated to perform various methods described herein associated with a host service.

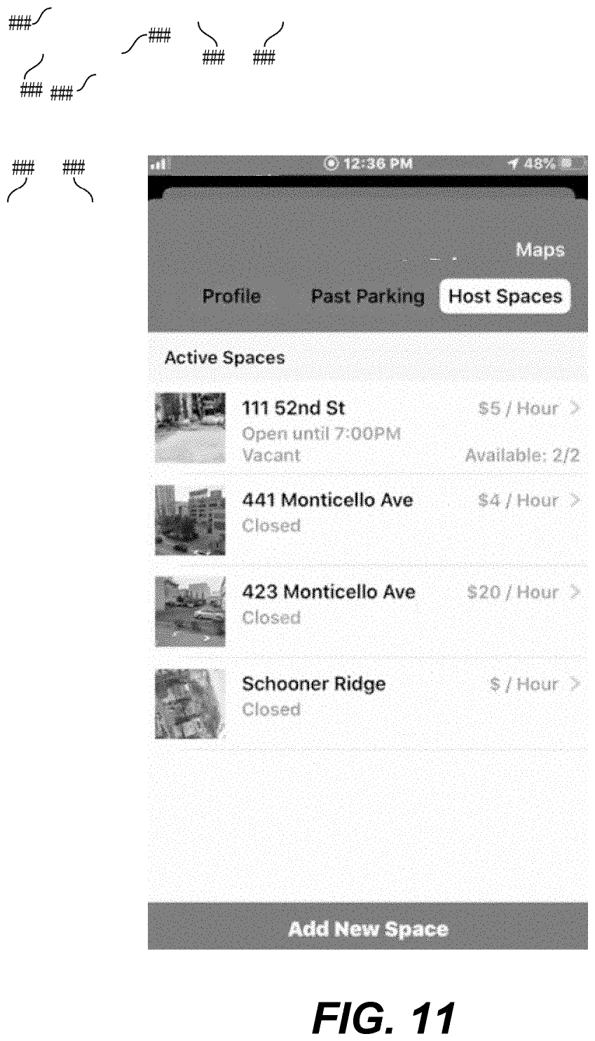

FIG. 11 illustrates an example GUI of a user device being operated to review an inventory of parking spaces.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for dynamic provisioning of parking spaces on-demand, the method comprising:
receiving, with a server, a search request from a first user device associated with a first user;
searching a register based on a user type and a location associated with the search request;
causing search results to be displayed on a first graphical user interface (“GUI”) for the first user device;
determining, with the server, linked user options based on a space asset selected from the search results and one of the search request and a user registration profile;
sending correspondence between the first user device and a second user device regarding the first space asset, the second user device being associated with a second user that is one of linked to the first user and controls access to the space asset;
causing a portion of the linked user options to be displayed on at least one of the first GUI and a second GUI of the second user device based on the correspondence and the first space asset; and
provisioning, with the server, the first space asset based on a first space provisioning agreement involving the first user and the second user, the provisioning including transmitting a first agreement confirmation to the first user device and the second user device.

2. The method of claim 1, wherein the first space asset is a parking space for one of an automobile and a boat.

3. The method of claim 1, further comprising:
monitoring utilization activity associated with a parking space associated with the first space asset,
wherein the monitoring includes causing a first notification to be displayed on the first GUI that requests the first user to check-in once a space consuming asset associated with the first user is located in the parking space.

4. The method of claim 3, further comprising causing a second notification to be displayed on the first GUI that requests the first user to check-out based on the first space provisioning agreement.

5. The method of claim 4, further comprising:
scanning, with the server, the network for a signal from the space consuming asset;
determining a location of the space consuming asset based on a result of the scanning; and
classifying the parking space as an available space asset based on the location.

6. The method of claim 1, further comprising:
receiving, with the first GUI, a selection of a linked user option from the portion of linked user options displayed;
transmitting a notification to at least one linked user based on the linked user option;
receiving a selection of a second space asset from a third user device of the at least one linked user, the second space asset and the first space asset related according to respective locations; and
provisioning the second space asset based on a second space provisioning agreement between the second user and the at least one linked user, the provisioning including transmitting a second agreement confirmation to the second user device and the third user device.

7. The method of claim 1, wherein the registration profile includes a first size, license information, and vehicle type for a space consuming asset identified in the first space provisioning agreement, and wherein the space asset includes at least one parking space having a second size greater than the first size.

8. A non-transitory, computer-readable medium containing instructions that, when executed by a hardware-based processor, performs stages for dynamic provisioning of parking spaces on-demand, the stages comprising:
receiving, with a server, a search request from a first user device associated with a first user;
searching a register based on a user type and a location associated with the search request;
causing search results to be displayed on a first graphical user interface (“GUI”) for the first user device;
determining, with the server, linked user options based on a space asset selected from the search results and one of the search request and a user registration profile;
sending correspondence between the first user device and a second user device regarding the first space asset, the second user device being associated with a second user that is one of linked to the first user and controls access to the first space asset;
causing a portion of the linked user options to be displayed on at least one of the first GUI and a second GUI of the second user device based on the correspondence and the first space asset; and
provisioning, with the server, the first space asset based on a first space provisioning agreement involving the first user and the second user, the provisioning including transmitting a first agreement confirmation to the first user device and the second user device.

9. The non-transitory, computer-readable medium of claim 8, wherein the first space asset is a parking space for one of an automobile and a boat.

10. The non-transitory, computer-readable medium of claim 8, the stages further comprising:
monitoring utilization activity associated with a parking space associated with the first space asset,
wherein the monitoring includes causing a first notification to be displayed on the first GUI that requests the first user to check-in once a space consuming asset associated with the first user is located in the parking space.

11. The non-transitory, computer-readable medium of claim 10, the stages further comprising causing a second notification to be displayed on the first GUI that requests the first user to check-out based on the first space provisioning agreement.

12. The non-transitory, computer-readable medium of claim 11, the stages further comprising:
scanning, with the server, the network for a signal from the space consuming asset;
determining a location of the space consuming asset based on a result of the scanning; and
classifying the parking space as an available space asset based on the location.

13. The non-transitory, computer-readable medium of claim 8, the stages further comprising:
receiving, with the first GUI, a selection of a linked user option from the portion of linked user options displayed;
transmitting a notification to at least one linked user based on the linked user option;
receiving a selection of a second space asset from a third user device of the at least one linked user, the second space asset and the first space asset related according to respective locations; and
provisioning the second space asset based on a second space provisioning agreement between the second user and the at least one linked user, the provisioning including transmitting a second agreement confirmation to the second user device and the third user device.

14. The non-transitory, computer-readable medium of claim 8, wherein the registration profile includes a first size, license information, and vehicle type for a space consuming asset identified in the first space provisioning agreement, and wherein the space asset includes at least one parking space having a second size greater than the first size.

15. A system for dynamic provisioning of parking spaces on-demand dynamic provisioning of parking spaces on-demand, the system comprising:
a memory storage including a non-transitory, computer-readable medium comprising instructions; and
a server including a hardware-based processor that executes the instructions to carry out stages comprising:
receiving, with the server, a search request from a first user device associated with a first user;
searching a register based on a user type and a location associated with the search request;
causing search results to be displayed on a first graphical user interface (“GUI”) for the first user device;
determining, with the server, linked user options based on a space asset selected from the search results and one of the search request and a user registration profile;
sending correspondence between the first user device and a second user device regarding the first space asset, the second user device being associated with a second user that is one of linked to the first user and controls access to the space asset;
causing a portion of the linked user options to be displayed on at least one of the first GUI and a second GUI of the second user device based on the correspondence and the first space asset; and
provisioning, with the server, the first space asset based on a first space provisioning agreement involving the first user and the second user, the provisioning including transmitting a first agreement confirmation to the first user device and the second user device.

16. The system of claim 15, wherein the first space asset is a parking space for one of an automobile and a boat.

17. The system of claim 15, the stages further comprising:
monitoring utilization activity associated with a parking space associated with the first space asset,
wherein the monitoring includes causing a first notification to be displayed on the first GUI that requests the first user to check-in once a space consuming asset associated with the first user is located in the parking space.

18. The system of claim 15, that stages further comprising causing a second notification to be displayed on the first GUI that requests the first user to check-out based on the first space provisioning agreement.

19. The system of claim 15, the stages further comprising:
scanning, with the server, the network for a signal from the space consuming asset;
determining a location of the space consuming asset based on a result of the scanning; and
classifying the parking space as an available space asset based on the location.

20. The system of claim 15, the stages further comprising:
receiving, with the first GUI, a selection of a linked user option from the portion of linked user options displayed;
transmitting a notification to at least one linked user based on the linked user option;
receiving a selection of a second space asset from a third user device of the at least one linked user, the second space asset and the first space asset related according to respective locations; and
provisioning the second space asset based on a second space provisioning agreement between the second user and the at least one linked user, the provisioning including transmitting a second agreement confirmation to the second user device and the third user device.
